(19) United States
(12) Patent Application Publication
(10) Pub. No.: US 2024/0062566 A1
(43) Pub. Date: Feb. 22, 2024

(54) INFORMATION PROCESSING APPARATUS, INFORMATION PROCESSING METHOD, AND NON-TRANSITORY COMPUTER READABLE MEDIUM

(71) Applicant: FUJIFILM Business Innovation Corp., Tokyo (JP)

(72) Inventors: Mitsuru SATO, Kanagawa (JP); Aya KUWANO, Kanagawa (JP); Eri SATO, Kanagawa (JP); Kohei Kaibara, Kanagawa (JP)

(73) Assignee: FUJIFILM Business Innovation Corp., Tokyo (JP)

(21) Appl. No.: 18/182,525

(22) Filed: Mar. 13, 2023

(30) Foreign Application Priority Data
Aug. 19, 2022 (JP) 2022-131307

(51) Int. Cl. G06V 30/14; G06V 30/40; G06K 7/12

(52) U.S. Cl. CPC G06V 30/1448; G06V 30/40; G06K 7/12

(57) ABSTRACT

An information processing apparatus includes a processor configured to, in a case of performing predetermined processing with respect to an area to be processed in multiple documents, perform the processing on a first document by using an area to be processed that is specified using a predetermined marker as a reference area, and perform the processing on a second or subsequent document with the reference area specified in the first document as the area to be processed.

### CROSS-REFERENCE TO RELATED APPLICATIONS

This application is based on and claims priority under 35 USC 119 from Japanese Patent Application No. 2022-131307 filed Aug. 19, 2022.

### BACKGROUND

### (i) Technical Field

The present disclosure relates to an information processing apparatus, an information processing method, and a non-transitory computer readable medium.

### (ii) Related Art

The following technologies relate to specifying an area to be processed in a document.

Japanese Patent No. 6019872 discloses a data conversion kit designed to alleviate the burden of preparations for automatic processing after acquiring a large number of sources to be converted into data and utilized.

The data conversion kit includes an information processing terminal that captures an image of a source to be acquired, and a support which is a card, a sheet, or a thin plate of paper, resin, or fabric that supports the source during image capture.

In the data conversion kit, the support is provided with: a placement area where a source to be acquired is placed, the placement area being rectangular in a plan view and conforming to the general shape and dimensions of the source to be acquired; and an outer area adjacent to the outside of the placement area, the outer area being where information stipulating the content of processing to be executed on a captured image that the information processing terminal acquires by capturing an image of the source to be acquired is written down manually by the user or is attached or printed as a sticker.

In addition, in the data conversion kit, the information processing terminal is provided with: an image capture unit that captures an image of both the outer area and the source to be acquired that is placed in the placement area on the support; and an information processing unit that obtains the captured image by extracting, from the image captured by the image capture unit, the portion of the placement area or the source to be acquired that is placed in the placement area, and also reads the information expressed in the outer area to execute multiple processes corresponding to the information on the captured image.

Japanese Unexamined Patent Application Publication No. 2013-161425 discloses a trimming program for a mobile phone, the trimming program being for the purpose of automatically trimming photographic data captured by a camera of the mobile phone.

The trimming program for a mobile phone is installable in a mobile phone including a camera, a processor that processes data obtained by image capture, and a memory, and the program processes photographic data obtained by using the camera to capture an image of an area on a document enclosed by a rectangular virtual frame formed by placing four markers indicating the desire to save the area as an image, together with the four markers.

Additionally, the trimming program for a mobile phone includes a step of automatically detecting the four markers from the photographic data and a step of generating image data by automatically trimming, from the photographic data, the rectangular area demarcated by the detected four markers.

### SUMMARY

In the case of using markers to specify a partial area to be processed in a document, if there are multiple documents, there is the problem of providing the markers to each of the multiple documents.

Aspects of non-limiting embodiments of the present disclosure relate to specifying an area to be processed for each of multiple documents without having to provide markers indicating the area to be processed in each document.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus comprising a processor configured to, in a case of performing predetermined processing with respect to an area to be processed in a plurality of documents, perform the processing on a first document by using an area to be processed that is specified using a predetermined marker as a reference area, and perform the processing on a second or subsequent document with the reference area specified in the first document as the area to be processed.

### BRIEF DESCRIPTION OF THE DRAWINGS

An exemplary embodiment of the present disclosure will be described in detail based on the following figures, wherein:

FIG. 1 is a perspective view illustrating an example of an overall configuration of an image processing apparatus according to an exemplary embodiment;

FIG. 2 is a block diagram illustrating an example of a hardware configuration of an electrical system of the image processing apparatus according to the exemplary embodiment;

FIG. 3 is a block diagram illustrating an example of a functional configuration of the image processing apparatus according to the exemplary embodiment;

FIG. 4 is a plan view illustrating an example of a marker arrangement with respect to the image processing apparatus according to the exemplary embodiment;

FIG. 5 is a schematic diagram illustrating an example of the structure of a marker-related information database according to the exemplary embodiment;

FIG. 6 is a schematic diagram illustrating an example of the structure of a process-related information database according to the exemplary embodiment;

FIG. 7 is a flowchart illustrating an example of information processing according to the exemplary embodiment;

FIG. 8 is a front view illustrating an example of a preview screen according to the exemplary embodiment;

FIG. 9 is a front view illustrating an example of an error display screen according to an exemplary embodiment; and

FIG. 10 is a perspective view illustrating an example of an overall configuration of an image processing apparatus according to another exemplary embodiment.

### DETAILED DESCRIPTION

Hereinafter, an exemplary embodiment of the present disclosure will be described in detail and with reference to the drawings. Note that the present exemplary embodiment describes an example in which an information processing apparatus according to the technology of the present disclosure is applied to an image processing apparatus which is set up in an office and which includes a document camera. However, the technology of the present disclosure is not limited to being applied to an office setting and may also be applied to any place where an image processing apparatus could be installed, such as at a school or inside the home. Moreover, the technology of the present disclosure is not limited to being applied to an image processing apparatus and may also be applied to any apparatus that executes some kind of processing with respect to a multi-page document, such as an image reading apparatus that reads images or an image transmission apparatus that transmits read images to another apparatus.

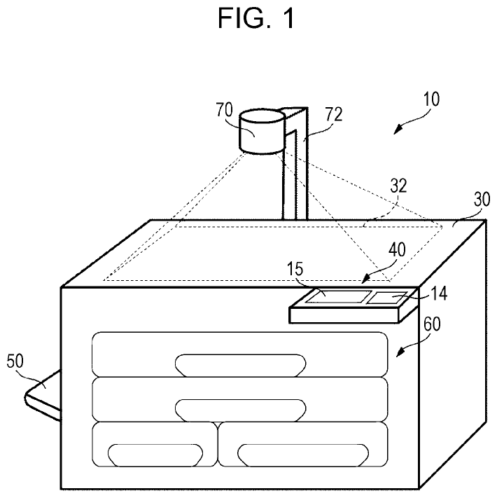

First, FIG. 1 will be referenced to describe a configuration of an image processing apparatus 10 according to the present exemplary embodiment. FIG. 1 is a perspective view illustrating an example of an overall configuration of the image processing apparatus 10 according to the present exemplary embodiment.

As illustrated in FIG. 1, the image processing apparatus 10 according to the present exemplary embodiment is provided with a document bed 30 on the upper surface of which a document is placed, a user interface unit (hereinafter referred to as the “UI unit”) 40 that displays various information and is used to input various information, a tray 50 that delivers paper on which an image is formed, and a paper feed unit 60 that feeds various types of paper.

Also, the image processing apparatus 10 according to the present exemplary embodiment is provided with a document camera 70 configured to capture an image of the upper side of the document bed 30. The document camera 70 according to the present exemplary embodiment is provided on the other end of an arm 72 of which one end is secured to the back side of the document bed 30, and is positioned so that the image capture angle of view substantially coincides with a document placement area 32 on the document bed 30.

Note that in the present exemplary embodiment, a camera that captures a color image is applied as the document camera 70, but the document camera 70 is not limited thereto. For example, a camera that captures a monochrome image or a grayscale image may also be applied as the document camera 70.

On the other hand, the UI unit 40 according to the present exemplary embodiment is provided with an input unit 14 with various types of switches and a display unit 15 including a liquid crystal display panel or the like. The display unit 15 according to the present exemplary embodiment is configured as what is called a touch panel display provided with a transmissive touch panel on the front side of the display.

Note that in the present exemplary embodiment, a digital multi-function device including functions such as an image printing function, an image reading function, and an image transmitting function is applied as the image processing apparatus 10. However, the configuration is not limited to the above, and another image processing apparatus, such as an image processing apparatus including only an image printing function or an image processing apparatus including only an image printing function and an image reading function, may also be applied as the image processing apparatus 10.

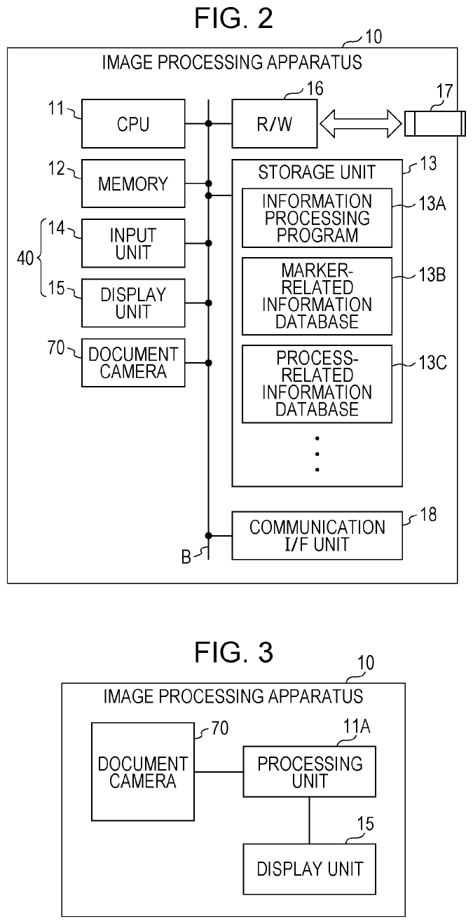

Next, FIG. 2 will be referenced to describe a configuration of an electrical system of the image processing apparatus 10 according to the present exemplary embodiment. FIG. 2 is a block diagram illustrating an example of a hardware configuration of an electrical system of the image processing apparatus 10 according to the present exemplary embodiment.

As illustrated in FIG. 2, the image processing apparatus 10 according to the present exemplary embodiment is provided with a central processing unit (CPU) 11 as a processor, a memory 12 as a temporary storage area, a non-volatile storage unit 13, and the UI unit 40 including the input unit 14 and display unit 15 described above. The image processing apparatus 10 according to the present exemplary embodiment is also provided with a media reading/writing device (R/W) 16, a communication interface (I/F) unit 18, and the document camera 70 described above. The CPU 11, memory 12, storage unit 13, UI unit 40, media reading/writing device 16, communication OF unit 18, and document camera 70 are interconnected through a bus B. The media reading/writing device 16 reads out information written to a recording medium 17 and writes information to the recording medium 17.

The storage unit 13 according to the present exemplary embodiment is realized by a hard disk drive (HDD), a solid-state drive (SSD), flash memory, or the like. An information processing program 13A is stored in the storage unit 13, which acts as a storage medium. The information processing program 13A is stored (installed) in the storage unit 13 by connecting the recording medium 17 with the information processing program 13A written thereto to the media reading/writing device 16 and causing the media reading/writing device 16 to read out the information processing program 13A from the recording medium 17. The CPU 11 reads out and loads the information processing program 13A from the storage unit 13 into the memory 12, and sequentially executes processes included in the information processing program 13A.

In addition, a marker-related information database 13B and a process-related information database 13C are stored in the storage unit 13. Note that the marker-related information database 13B and the process-related information database 13C will be described in detail later.

Next, FIG. 3 will be referenced to describe a functional configuration of the image processing apparatus 10 according to the present exemplary embodiment. FIG. 3 is a block diagram illustrating an example of a functional configuration of the image processing apparatus 10 according to the present exemplary embodiment.

As illustrated in FIG. 3, the image processing apparatus 10 according to the present exemplary embodiment includes a processing unit 11A. The CPU 11 of the image processing apparatus 10 functions as the processing unit 11A by executing the information processing program 13A.

When performing predetermined processing on an area to be processed in multiple documents, the processing unit 11A according to the present exemplary embodiment performs the processing on the first document by using an area to be processed that is specified using predetermined markers as a reference area. In contrast, for the second and subsequent documents, the processing unit 11A according to the present exemplary embodiment performs the processing with the reference area specified in the first document as the area to be processed.

In the present exemplary embodiment, a marker expressed by a machine-readable code, such as a barcode or a two-dimensional code, is applied as the markers. Also, in the present exemplary embodiment, a code that includes information indicating the content of the processing is applied as the machine-readable code. However, the markers are not limited to the above, and markers that do not include a machine-readable code or other code may also be applied. In this case, the content of the processing may be stipulated according to differences in appearance, such as the shape, size, and color of the markers. Furthermore, even if a machine-readable code is used as the markers, the content of the processing may be stipulated according to the type of color of the markers.

Also, the processing unit 11A according to the present exemplary embodiment applies the reference area to the second and subsequent documents if the second or subsequent document conforms to predetermined characteristics of the first document.

In the present exemplary embodiment, the two characteristics of the dimensions and color of the document area are applied as the characteristics, but the characteristics are not limited thereto. For example, one characteristic or a combination of multiple characteristics from among the layout, color scheme, and title of the document may also be applied in addition to the above two characteristics. As a further example, some kind of characteristic related to the document, such as the presence or absence of ruled lines, the size of characters, or the presence or absence of a predetermined logo, may also be applied as the characteristics.

Also, in the present exemplary embodiment, processing related to an image reading process using the document camera 70 is applied as the processing, but the configuration is not limited thereto. For example, processing unrelated to the document camera 70, such as a scan process by the image processing apparatus 10 for reading a document as an image, or the processing of an image captured by a camera-equipped smartphone acting as an image processing apparatus, may also be applied as the processing.

Also, in the case in which the area to be processed is not specified successfully, the processing unit 11A according to the present exemplary embodiment presents an indication that specification is unsuccessful. Note that in the present exemplary embodiment, a presentation given via a display by the display unit 15 of the UI unit 40 is applied as the presentation indicating that specification is unsuccessful, but the configuration is not limited thereto. For example, a presentation given by image formation by the image processing apparatus 10 or a presentation given by sound produced by a sound playback device may also be applied as the presentation indicating that specification is unsuccessful.

Also, in the present exemplary embodiment, the case in which the area to be processed contains no characters is applied as the case in which the area to be processed is not specified successfully, but the configuration is not limited thereto. For example, cases such as when the area to be processed is itself difficult to recognize because of a folded or soiled document may also be applied as the case in which the area to be processed is not specified successfully.

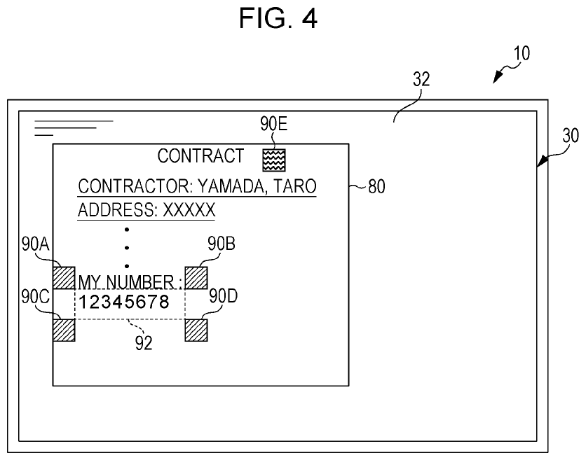

Next, FIG. 4 will be referenced to describe a method of placing markers on the image processing apparatus 10. FIG. 4 is a plan view illustrating an example of a marker arrangement with respect to the image processing apparatus 10 according to the present exemplary embodiment.

As illustrated in FIG. 4, in the image processing apparatus 10 according to the present exemplary embodiment, when performing various processing using the document camera 70, the user first places a document 80 at any position in the document placement area 32 of the document bed 30.

As described above, a machine-readable code is used for markers 90A, 90B, and so on according to the present exemplary embodiment. Note that hereinafter, the markers 90A, 90B, and so on will be collectively referred to as the “markers 90” when not being distinguished individually.

Various types of markers 90 are prepared as the markers 90 according to the present exemplary embodiment and are classified into multiple types, such as area specification markers for specifying the area to be processed according to the positions where the markers are placed and execution process specification markers indicating the content of the processing to be executed.

Additionally, as illustrated in FIG. 4, in the case of specifying an area to be processed with respect to the document 80 placed on the document bed 30, the user places area specification markers 90A to 90D at the positions of the four corners of the area to be processed. In this way, the present exemplary embodiment describes a case in which a rectangle is used as the shape of the area to be processed and the markers 90 are placed at the four corners of a rectangular area to be processed as the method of specifying the area to be processed, but the configuration is not limited thereto. For example, a rectangle may be applied as the shape of the area to be processed and the markers 90 may be placed at a pair of diagonally opposite corners of the rectangular area to be processed as the method of specifying the area to be processed. Moreover, the shape of the area to be processed is not limited to a rectangle, and another shape such as a triangle, a trapezoid, a pentagon, or a larger polygon, or a shape such as a circle may also be applied.

In the present exemplary embodiment, markers that also indicate the content of the processing to be executed with respect to the specified area to be processed are applied as the area specification markers 90, and examples of the content of the processing in this case include a trimming process, a masking process, an optical character recognition/reader (OCR) process, and the like. Note that examples of the content of the processing for the execution process specification markers 90 include a forwarding process via email attachment or email notification, a printing (image forming) process, and the like.

In the example illustrated in FIG. 4, area specification markers 90 that indicate a masking process are applied as markers 90A to 90D, and in this case, a masking process is performed on an area 92 to be processed (in the example illustrated in FIG. 4, the area enclosing the numerals of a Japanese government-issued Individual Number, also known as a My Number) that is enclosed by the markers 90.

Also, in the example illustrated in FIG. 4, a marker 90E is an execution process specification marker 90, and in this case, there are no particular limitations on the position where the marker 90E is placed, and the marker 90E may be placed anywhere in the document placement area 32, inside or outside the upper surface of the document 80.

In the image processing apparatus 10 according to the present exemplary embodiment, as described above, when performing predetermined processing on an area to be processed in multiple documents 80, the processing is performed on the first document 80 by using an area to be processed that is specified using the markers 90 as a reference area. In contrast, for the second and subsequent documents 80, the processing is performed with the reference area specified in the first document 80 as the area to be processed.

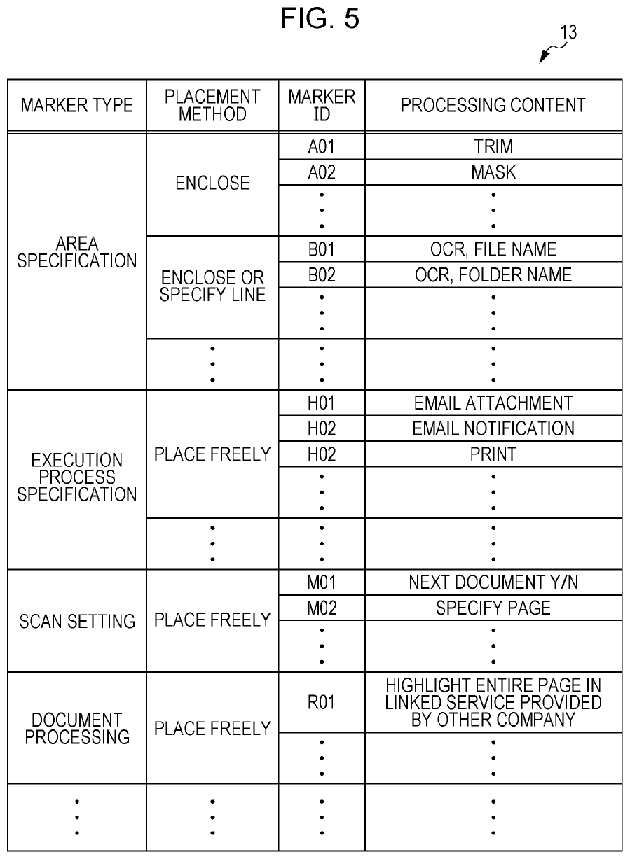

Next, FIG. 5 will be referenced to describe the marker-related information database 13B according to the present exemplary embodiment. FIG. 5 is a schematic diagram illustrating an example of the structure of the marker-related information database 13B according to the present exemplary embodiment.

The marker-related information database 13B according to the present exemplary embodiment is a database in which information related to the markers 90 described above is registered. In one example, as illustrated in FIG. 5, information pertaining to each of a marker type, a placement method, a marker identification (ID), and processing content is associated with each other and stored in the marker-related information database 13B according to the present exemplary embodiment.

The marker type is information indicating the type of the markers 90 described above, and the placement method is information indicating the method of placing the markers 90 described above. Also, the marker ID is preassigned information which is different for each type of marker and each type of processing content to identify the corresponding marker, and the processing content is information indicating the content of the processing represented by the corresponding marker.

In the example illustrated in FIG. 5, for instance, for the marker 90 assigned “A01” as the marker ID, information is registered to indicate that the type is area specification, the placement method is a method of enclosing the area to be processed, and the content of the processing is the trimming of an image. Accordingly, by referencing the marker-related information database 13B, it is possible to ascertain the type, placement method, and content of processing for a marker 90 preregistered in the database.

That is, in the present exemplary embodiment, information indicating the content of the processing is itself not included in the marker 90, but information indicating the marker ID is included in the marker 90. Furthermore, in the present exemplary embodiment, by acquiring information indicating the content of the processing corresponding to the marker ID from the marker-related information database 13B, the content of the corresponding processing is specified. However, the configuration is not limited to the above, and information indicating the content of the processing itself may also be included in the marker 90. In this case, the marker-related information database 13B would be unnecessary.

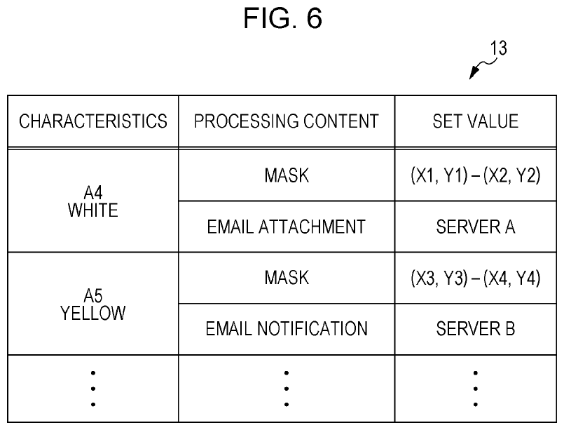

Next, FIG. 6 will be referenced to describe the process-related information database 13C according to the present exemplary embodiment. FIG. 6 is a schematic diagram illustrating an example of the structure of the process-related information database 13C according to the present exemplary embodiment.

The process-related information database 13C according to the present exemplary embodiment is a database in which information related to processed specified by the user using the markers 90 is registered. In one example, as illustrated in FIG. 6, information pertaining to each of characteristics, processing content, and a set value is associated with each other and stored in the process-related information database 13C according to the present exemplary embodiment.

The characteristics are information indicating the characteristics described above, the processing content is information indicating the content of processing to be performed on a document with the corresponding characteristics, and the set value is information to be set with respect to the corresponding processing.

Note that in the case in which the markers 90 are area specification markers, an area to be processed in a single location is specified by a set of four markers 90, and singular coordinate information indicating the area to be processed that is specified by the placement positions of the set of markers 90 is applied as the set value in this case. In the present exemplary embodiment, information indicating coordinates in a two-dimensional coordinate system with the origin set to the upper-left corner of the document 80 is applied as the coordinate information, but the coordinate information is not limited thereto. For example, information indicating coordinates in a two-dimensional coordinate system with the origin set to any of the lower-left corner, the upper-right corner, and the lower-right corner among the four corners of the document 80 may also be applied as the coordinate information. Also, in the present exemplary embodiment, as illustrated in FIG. 6, information indicating the positions of a pair of diagonally opposite corners of the area to be processed is applied as the coordinate information indicating the area to be processed, but obviously the coordinate information is not limited thereto.

In this way, in the present exemplary embodiment, since one of the corners of the document 80 is applied as the coordinate system indicating the position of the area to be processed, it is possible to place the document 80 at any position in the document placement area 32.

Also, in the case in which the markers 90 are markers for a purpose other than area specification, a single set value may be set with respect to a single marker 90. For example, in the case in which the content of the processing is a forwarding process via email attachment, information indicating the forwarding destination (in the present exemplary embodiment, a device name) is the set value, whereas in the case in which the content of the processing is printing, a set value is unnecessary.

Note that, to avoid confusion, the present exemplary embodiment describes a case in which a relevant set value, such as the above information indicating a forwarding destination, is registered in advance, but the configuration is not limited thereto. For example, the user or someone else may also be prompted to input a set value, as appropriate.

In the example illustrated in FIG. 6, for instance, for a document 80 with the characteristics of being A4 size and white color among the second and subsequent documents 80, information for performing a masking process with respect to a rectangular area having a pair of diagonally opposite corners located at (X1, Y1)-(X2, Y2) is registered. Also, in the example illustrated in FIG. 6, processing by which image information representing the document 80 obtained from the masking process is transmitted as an email attachment to a server A is registered as the processing with respect to all of the documents 80.

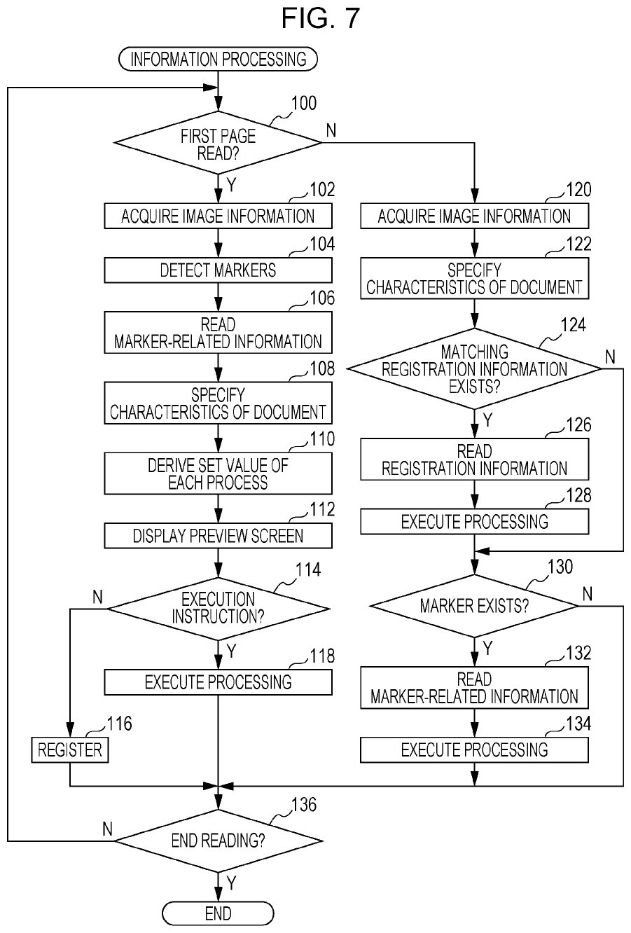

Next, FIGS. 7 to 9 will be referenced to describe the actions of the image processing apparatus 10 when executing information processing. FIG. 7 is a flowchart illustrating an example of information processing according to the present exemplary embodiment.

The information processing illustrated in FIG. 7 is executed by the CPU 11 of the image processing apparatus 10 executing the information processing program 13A if an instruction to execute information processing is given by the user through the UI unit 40. Before giving the instruction to execute information processing, the user is assumed to place the first document 80 in the document placement area 32 and places the markers 90 according to the desired processing. Note that the method of executing the information processing is not limited to such a user-directed method. For example, the information processing may also be executed if the document 80 and the markers 90 are placed in the document placement area 32 of the document bed 30 when the elapsed time since the execution of the information processing was last completed is equal to a predetermined period (in the present exemplary embodiment, 10 minutes) or longer.

In step 100 of FIG. 7, the CPU 11 determines whether the document 80 placed on the document bed 30 is the first document since the start of the current information processing, and proceeds to step 102 in the case of a positive determination. In step 102, the CPU 11 instructs the document camera 70 to capture an image, and acquires image information obtained by the document camera 70 in response to the instruction.

In step 104, the CPU 11 detects images of the markers 90 from the image expressed by the acquired image information. In step 106, the CPU 11 specifies the marker ID indicated by the detected markers 90, and reads out all information corresponding to the specified marker ID (hereinafter referred to as “marker-related information”) from the marker-related information database 13B. Note that in the present exemplary embodiment, the images of the markers 90 are detected using known pattern matching technology of the related art, but the detection is not limited thereto. For example, the images of the markers 90 may be detected by artificial intelligence (AI) using a pre-trained segmentation model such as a semantic segmentation model or an instance segmentation model.

In step 108, the CPU 11 specifies predetermined types of characteristics (in the present exemplary embodiment, the dimensions and color of the document 80) from the image (hereinafter referred to as the “document image”) 15A of the document 80 included in the image expressed by the acquired image information. Note that in the present exemplary embodiment, standard sizes such as A4 size and B5 size are applied as the dimensions of the document 80, but the dimension are not limited thereto, and the actual size in height and width may also be applied as the dimensions of the document 80.

In step 110, the CPU 11 derives the set value corresponding to the processing according to each of the detected markers 90 as described above.

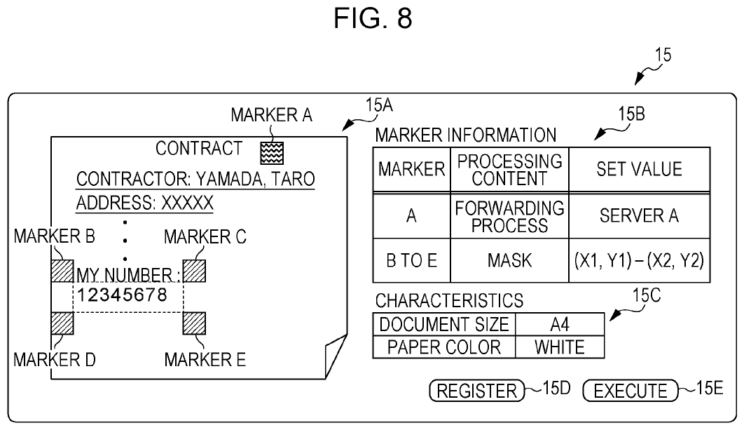

In step 112, the CPU 11 uses the various information obtained by the above processing to control the display unit 15 to display a preview screen with a predefined layout. FIG. 8 illustrates an example of the preview screen according to the present exemplary embodiment.

As illustrated in FIG. 8, on the preview screen according to the present exemplary embodiment, the document image 15A is displayed together with names, such as marker A and marker B, individually assigned to each image of the markers 90. Also, on the preview screen according to the present exemplary embodiment, an image (hereinafter referred to as the “table image”) 15B is displayed in which each of the detected markers 90 is associated with the corresponding processing content and set value in a table layout. Furthermore, on the preview screen according to the present exemplary embodiment, a characteristics image 15C is displayed to indicate the characteristics of the document 80 specified by the processing in step 108.

If the preview screen illustrated in FIG. 8 is displayed, the user designates a register button 15D through the UI unit 40 in the case of registering the processing content and set value of each marker displayed in the table image 15B in association with the characteristics displayed in the characteristics image 15C. In contrast, the user designates an execute button 15E through the UI unit 40 in the case of executing processing with the displayed content by applying the displayed set values.

Accordingly, in step 114, the CPU 11 determines whether the execute button 15E is designated by the user, and in the case of a negative determination, regards the register button 15D as being designated and proceeds to step 116.

In step 116, the CPU 11 registers, in the process-related information database 13C, information indicating the characteristics displayed by the characteristics image 15C in association with the processing content and set values displayed by the table image 15B, and thereafter proceeds to step 136.

On the other hand, in the case of a positive determination in step 114, that is, if the execute button 15E is designated by the user, the CPU 11 proceeds to step 118, executes the processing specified by each of the markers 90, and then proceeds to step 136.

If the user designates the execute button 15E on the preview screen, the processing with respect to the first document 80 is regarded as finished, and the document 80 placed on the document bed 30 is replaced by the next document 80. Also, in the case of wanting to designate new processing except for the specification of the area to be processed, the user places markers 90 corresponding to the processing in the document placement area 32 of the document bed 30. In response to the operations by the user, the processing in step 100 returns a negative determination, and the flow proceeds to step 120. Thereafter, the user successively performs similar operations for the documents 80 to be processed.

In step 120, the CPU 11 instructs the document camera 70 to capture an image, and acquires image information obtained by the document camera 70 in response to the instruction.

In step 122, similarly to the processing in step 108, the CPU 11 specifies the predetermined types of characteristics (in the present exemplary embodiment, the dimensions and color of the document 80) from the document image 15A corresponding to the acquired image information, that is, from the document image 15A of the second or subsequent document 80.

In step 124, the CPU 11 determines whether information indicating characteristics matching the specified characteristics is registered in the process-related information database 13C, and proceeds to step 130 in the case of a negative determination or proceeds to step 126 in the case of a positive determination.

In step 126, the CPU 11 reads, from the process-related information database 13C, the processing content and set value corresponding to the information indicating the characteristics determined to be matching in the processing of step 124. In step 128, the CPU 11 executes processing corresponding to the read processing content and set value, and thereafter proceeds to step 130.

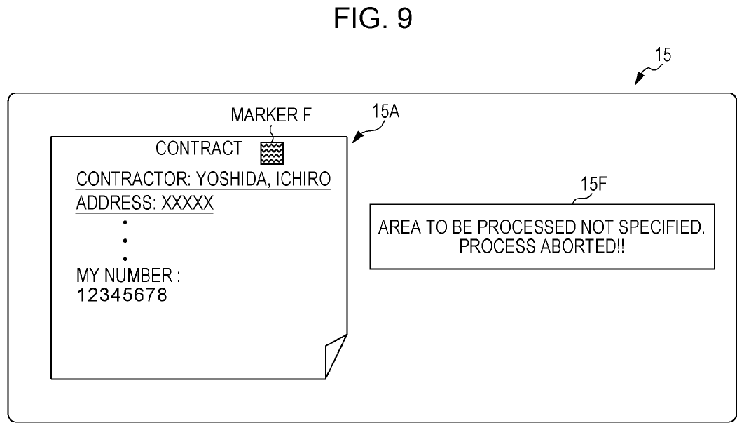

Note that when executing the processing in step 128, in the case in which the area to be processed that is indicated by the read set value is not specified successfully, the CPU 11 controls the display unit 15 to display an error display screen including an error message 15F, an example of which is illustrated in FIG. 9. Additionally, in this case, the CPU 11 forcibly terminates the current information processing after causing the error display screen to be displayed. Note that in the present exemplary embodiment, the case in which the area to be processed contains no characters is applied as the case in which the area to be processed is not specified successfully, but the configuration is not limited thereto. For example, the case in which the area to be processed extends out past the edge of the document 80 may also be applied as the case in which the area to be processed is not specified successfully.

In step 130, the CPU 11 determines whether the markers 90 are included in the image expressed by the acquired image information, and proceeds to step 136 in the case of a negative determination, or proceeds to step 132 in the case of a positive determination.

In step 132, the CPU 11 reads marker-related information corresponding to the detected markers 90 from the marker-related information database 13B, similarly to the processing in step 106. In step 134, the CPU 11 executes the processing corresponding to the read marker-related information, and then proceeds to step 136.

In step 136, the CPU 11 determines whether a predetermined end timing as a timing at which to end the current information processing has been reached, and returns to step 100 in the case of a negative determination or ends the current information processing in the case of a positive determination. In the present exemplary embodiment, the timing at which a marker 90 is used to indicate that there is no next document 80 is applied as the end timing, but the end timing is not limited thereto. For example, the timing at which instruction input for ending the information processing is given through the UI unit 40 may also be applied as the end timing.

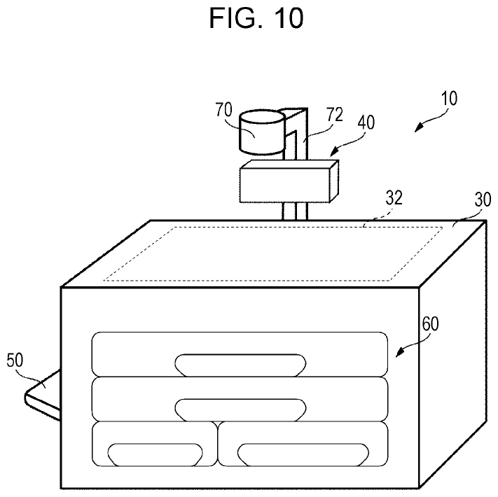

Note that the exemplary embodiment above describes a case of applying the technology of the present disclosure to an image processing apparatus 10 with the UI unit 40 located on the front side of the apparatus, as illustrated in FIG. 1, for instance, but the configuration is not limited thereto. For example, as illustrated in FIG. 10, the technology of the present disclosure may also be applied to an image processing apparatus 10 with the UI unit 40 located on the back side of the apparatus (in the example illustrated in FIG. 10, on the arm 72 of the document camera 70).

Also, the exemplary embodiment above describes a case in which the area to be processed that has been specified in the first document 80 is applied without exception to the second and subsequent documents 80, but the configuration is not limited thereto. For example, a marker 90 may also be used to indicate whether the area to be processed that has been specified in the first document 80 is to be applied to the second and subsequent documents 80.

Also, the exemplary embodiment above describes a case in which information related to all of the applied markers 90 is displayed in the table image 15B on the preview screen, but the configuration is not limited thereto. For example, only information corresponding to the markers 90 that the user has specified with respect to the displayed document image 15A may be displayed as the table image 15B.

Also, although the physical type of the markers is not specifically mentioned in the exemplary embodiment above, any of various physical types of markers, such as a magnet type, a flat marble type, a tag type, or a sticker type, may be applied.

Also, although not mentioned in the exemplary embodiment above, characters indicating the processing content or the like may also be written on the markers 90, for example.

Also, the exemplary embodiment above describes a case in which only information indicating the content of the processing is included in the markers 90, but the configuration is not limited thereto. For example, the set value in addition to information indicating the content of the processing may also be included in the markers 90.

Also, the exemplary embodiment above describes a case in which various databases are registered in the image processing apparatus 10, but the configuration is not limited thereto. For example, various databases may be registered in an external apparatus such as a server apparatus configured to communicate with the image processing apparatus 10, and the external apparatus may be accessed, as appropriate.

The foregoing describes an exemplary embodiment, but the technical scope of the present disclosure is not limited to the scope described in the exemplary embodiment above. Various modifications or alterations may be made to the exemplary embodiment above within a scope that does not depart from the gist of the present disclosure, and any embodiments obtained by such modifications or alterations are also included in the technical scope of the present disclosure.

Furthermore, the exemplary embodiment above does not limit the present disclosure as stated in the claims, and not all combinations of features described in the exemplary embodiment are necessarily required as means for addressing the issues of the present disclosure. The exemplary embodiment described above includes various levels of disclosure, and the various disclosures are elicited through the combination of the multiple structural elements disclosed herein. Even if several structural elements are removed from among all of the structural elements illustrated in the exemplary embodiment, the configuration with the several structural elements removed therefrom may still be elicited as a disclosure insofar as an effect is obtained.

In the embodiments above, the term “processor” is broad enough to encompass one processor or plural processors in collaboration which are located physically apart from each other but may work cooperatively. The order of operations of the processor is not limited to one described in the embodiments above, and may be changed.

Furthermore, the exemplary embodiment above describes a case in which various processing is achieved by a software configuration using a computer by executing a program, but the present disclosure is not limited thereto. For example, various processing may also be achieved by a hardware configuration, or by a combination of a hardware configuration and a software configuration.

Otherwise, the configuration of the image processing apparatus 10 described in the exemplary embodiment above is an example, and obviously, unnecessary portions may be removed or new portions may be added within a scope that does not depart from the gist of the present disclosure.

Also, the flow of the information processing described in the exemplary embodiment above is an example, and obviously, unnecessary steps may be removed, new steps may be added, or the processing sequence may be rearranged within a scope that does not depart from the gist of the present disclosure.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing apparatus comprising:
a processor configured to:
   in a case of performing predetermined processing with respect to an area to be processed in a plurality of documents, perform the processing on a first document by using an area to be processed that is specified using a predetermined marker as a reference area, and perform the processing on a second or subsequent document with the reference area specified in the first document as the area to be processed.
(((2)))

The information processing apparatus according to (((1))), wherein the marker is a marker expressed by a machine-readable code.
(((3)))

The information processing apparatus according to (((2))), wherein the machine-readable code includes information indicating content of the processing.
(((4)))

The information processing apparatus according to (((3))), wherein the machine-readable code stipulates the content of the processing by type of color.
(((5)))

The information processing apparatus according to any one of (((1))) to (((4))), wherein the processor is configured to apply the reference area to the second or subsequent document if the second or subsequent document conforms to a predetermined characteristic of the first document.
(((6)))

The information processing apparatus according to (((5))), wherein the characteristic is at least one of a dimension, color, layout, color scheme, and title of the document.
(((7)))

The information processing apparatus according to any one of (((1))) to (((6))), wherein the processing is processing using a document camera.
(((8)))

The information processing apparatus according to (((7))), wherein the processing using the document camera is processing related to image reading processing.
(((9)))

The information processing apparatus according to any one of (((1))) to (((8))), wherein the processor is configured to, in a case in which the area to be processed is not specified successfully, present an indication that specification is unsuccessful.
(((10)))

The information processing apparatus according to (((9))), wherein the case in which the area to be processed is not specified successfully is a case in which the area to be processed contains no characters.

What is claimed is:

1. An information processing apparatus comprising:
a processor configured to:
in a case of performing predetermined processing with respect to an area to be processed in a plurality of documents, perform the processing on a first document by using an area to be processed that is specified using a predetermined marker as a reference area, and perform the processing on a second or subsequent document with the reference area specified in the first document as the area to be processed.

2. The information processing apparatus according to claim 1, wherein the marker is a marker expressed by a machine-readable code.

3. The information processing apparatus according to claim 2, wherein the machine-readable code includes information indicating content of the processing.

4. The information processing apparatus according to claim 3, wherein the machine-readable code stipulates the content of the processing by type of color.

5. The information processing apparatus according to claim 1, wherein the processor is configured to apply the reference area to the second or subsequent document if the second or subsequent document conforms to a predetermined characteristic of the first document.

6. The information processing apparatus according to claim 5, wherein the characteristic is at least one of a dimension, color, layout, color scheme, and title of the document.

7. The information processing apparatus according to claim 1, wherein the processing is processing using a document camera.

8. The information processing apparatus according to claim 7, wherein the processing using the document camera is processing related to image reading processing.

9. The information processing apparatus according to claim 1 wherein the processor is configured to, in a case in which the area to be processed is not specified successfully, present an indication that specification is unsuccessful.

10. The information processing apparatus according to claim 9, wherein the case in which the area to be processed is not specified successfully is a case in which the area to be processed contains no characters.

11. An information processing method comprising:
in a case of performing predetermined processing with respect to an area to be processed in a plurality of documents, performing the processing on a first document by using an area to be processed that is specified using a predetermined marker as a reference area, and performing the processing on a second or subsequent document with the reference area specified in the first document as the area to be processed.

12. A non-transitory computer readable medium storing a program causing a computer to execute a process comprising:
in a case of performing predetermined processing with respect to an area to be processed in a plurality of documents, performing the processing on a first document by using an area to be processed that is specified using a predetermined marker as a reference area, and performing the processing on a second or subsequent document with the reference area specified in the first document as the area to be processed.
